(19) United States
(12) Patent Application Publication
(10) Pub. No.: US 2026/0330463 A1
(43) Pub. Date: Oct. 22, 2026

(54) SYSTEM AND METHOD FOR MULTI-SUBACCOUNT PAYMENT PROCESSING

(71) Applicant: DavidShield PassportCard Ltd., Netanya (IL)

(72) Inventor: Leor Catalan, Netanya (IL)

(21) Appl. No.: 19/181,530

(22) Filed: Apr. 17, 2025

(51) Int. Cl. G06Q 20/40; G06Q 20/38

(52) U.S. Cl. CPC G06Q 20/403; G06Q 20/381; G06Q 20/389

(57) ABSTRACT

A method and system for processing transactions using a multi-subaccount instrument. The method includes receiving a request to authorize a transaction made by the multi-subaccount instrument at a transaction terminal. The multi-subaccount payment instrument is associated with multiple subaccounts each associated with transactions of different types. A selected subaccount is chosen from the multiple subaccounts based on information in the request and based on a policy associated with the selected subaccount. Based on the selection, the subaccount is used for the transaction.

### TECHNICAL FIELD

The present disclosure relates to payment processing systems in general, and to a system and method for processing payments using a multi-subaccount payment card, in particular.

### BACKGROUND

Persons and businesses move the global economy by purchasing goods and services. The purchases are made at virtual platforms, for example, mobile applications and web pages, and at physical points of sale. When paying at physical points of sale, persons may use cash, cheques, and physical (or virtual) cards, such as credit cards or debit cards. Such cards may be pre-paid or associated with a bank account of the person/business purchasing at the point of sale. In case a person wishes to purchase using such card, an electronic terminal performs an identification process versus the card to extract details that are unique to the card, such as card number, name of the card's owner and the like. The terminal then communicates with a payment server to receive authorization to complete the purchase, for example according to the balance related to the card. For example, in case the person charged the prepaid card with 1,000 USD, the payment server will reject a purchase in the sum of 1,100 USD. The purchase may be of goods or services.

When purchasing insurance, and upon an insurable event such as an accident, illness, or injury, the insured person may pay for insurance-related goods and services using a cash/credit card and later file a claim and applicable supporting documents to receive reimbursements from the insurance company. Some insurance companies offer their customers a payment card used to pay for the insurance-related goods or services at a payment terminal of the service provider. This way, the customer is not required to file a reimbursement claim.

### BRIEF SUMMARY

According to an aspect of the present disclosure, a method is provided. The method includes receiving a request to authorize a transaction made by a multi-subaccount payment instrument at a transaction terminal, wherein the multi-subaccount payment instrument is associated with multiple subaccounts, the multiple subaccounts comprise at least a first subaccount and a second subaccount, the first subaccount is configured to be used for transactions of a first type, the second subaccount is configured to be used for transactions of a second type. The method further includes selecting a selected subaccount from the multiple subaccounts, wherein said selecting is performed based on information included in the request and based on a policy that is associated with the selected subaccount. The method also includes verifying sufficient funds in the selected subaccount. In response to said verifying, the method includes allocating funds from the selected subaccount and sending an authorization message indicating that the transaction is approved.

According to other aspects of the present disclosure, the method may include one or more of the following features. Selecting the selected subaccount may comprise determining a priority order for the multiple subaccounts and selecting the subaccount with the highest priority that matches criteria in the transaction request. The criteria may include at least one of: merchant category code (MCC), transaction amount, transaction location, or transaction currency. Selecting may comprise selecting a potential subaccount based on the information included in the request, retrieving a policy associated with the potential subaccount, and determining whether the transaction is valid based on the policy of the potential subaccount and based on the information included in the request. The method may further comprise, if the transaction is invalid for the potential subaccount, selecting a next subaccount based on a predefined priority order. The method may also include notifying a user of the multi-subaccount payment instrument about the selection of the next subaccount. The policy associated with the selected subaccount may include rules for transaction types, spending limits, geographical restrictions, or time-based restrictions. The method may include performing a currency conversion if the transaction currency differs from the currency of the selected subaccount. Allocating funds from the selected subaccount may comprise updating a ledger balance of the selected subaccount in a database by deducting a transaction amount from the balance of the selected subaccount. The method may further comprise receiving a request to activate the selected subaccount, wherein the request to activate the selected subaccount is received before receiving the request to authorize the transaction, and injecting the selected subaccount with a maximum transaction amount, wherein the maximum transaction amount limits an amount of money the payment instrument can be used to pay using the selected subaccount. The receiving the request, selecting the subaccount, verifying sufficient funds, allocating funds, and transmitting the authorization message may be completed within a predetermined time threshold of four seconds from receipt of the request. Selecting the subaccount may be implemented using a serverless workflow orchestration mechanism in combination with one or more stateless compute functions, wherein relevant data is retrieved from a database using an initial stateless compute function, thereby reducing subsequent database calls, wherein the one or more stateless compute functions are maintained in a warm state, whereby facilitating efficient execution of said selecting the subaccount within a timeframe.

According to another aspect of the present disclosure, a system is provided. The system includes a transaction terminal, a database storing information about multiple subaccounts associated with a multi-subaccount payment instrument, wherein the multiple subaccounts comprise at least a first subaccount configured for transactions of a first type and a second subaccount configured for transactions of a second type, and a server. The server is configured to receive a request to authorize a transaction made by the multi-subaccount payment instrument at said transaction terminal, select a subaccount from the multiple subaccounts based on information included in the request and a policy associated with the selected subaccount in said database, verify sufficient funds in the selected subaccount, in response to verifying sufficient funds, allocate funds from the selected subaccount, and in response to verifying sufficient funds, send an authorization message indicating that the transaction is approved.

According to other aspects of the present disclosure, the system may include one or more of the following features. The transaction terminal and the server may be connected via an electronic transaction processing network, wherein the request is transmitted by said transaction terminal to said electronic transaction processing network and routed to said server, wherein the authorization message is transmitted by said server to said electronic transaction processing network and routed to said transaction terminal. The electronic transaction processing network may have a timeout constraint, wherein said server is configured to send the authorization within the timeout constraint. The server may implement at least a portion of a logic for selecting the subaccount using a serverless workflow orchestration mechanism in combination with one or more stateless compute functions. The one or more stateless compute functions may utilize data retrieved from said database using an initial stateless compute function, thereby reducing subsequent database calls. The one or more stateless compute functions may be maintained in a warm state, whereby facilitating efficient execution of selecting the subaccount within the timeout constraint. The policy associated with the selected subaccount may include rules for transaction types, spending limits, geographical restrictions, or time-based restrictions. The selection of the subaccount may comprise selecting a potential subaccount based on the information included in the request, retrieving from said database a policy associated with the potential subaccount, and determining whether the transaction is valid based on the policy of the potential subaccount and based on the information included in the request.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a method for processing payments, in accordance with some to embodiments of the disclosed subject matter;

FIG. 2 shows a method for applying rules on payments made by a payment card, in accordance with some to embodiments of the disclosed subject matter;

FIG. 3 shows a computerized environment for handling payments, in accordance with some to embodiments of the disclosed subject matter;

FIG. 4 shows an illustration of a computerized environment in which the payment is being processed, in accordance with some to embodiments of the disclosed subject matter; and

FIG. 5 shows a flowchart for processing a transaction authorization request, in accordance with some embodiments of the disclosed subject matter.

### DETAILED DESCRIPTION

Illustrative embodiments of the invention are described below. In the interest of clarity, not all features/components of an actual implementation are necessarily described.

One technical problem dealt with by the disclosed subject matter is efficiently processing payments made using a single payment card across multiple subaccounts with different usage rules and funding sources. Traditional payment systems typically associate a single account or funding source with each payment card, limiting flexibility and requiring users to carry multiple cards for different purposes. This approach increases complexity for users, raises the risk of using the wrong card, and fails to leverage the potential of modern digital payment infrastructures.

It may be desired to avoid using multiple cards for different needs or attributes. For example, a person may have several different credit/debit cards, each used for a different purpose or associated with a different account. One card may be associated with the person's business account, while the other may be associated with the person's personal account. In some cases, one card may be used for payments made in foreign currency. As yet another example, one card may be an insurance payment card intended to purchase insurance-related goods and services according to an insurance contract..

For the avoidance of doubt, the term “payment card” is not to be limited to a physical card. Payment card may be a virtual payment card, such as implemented using Google Pay™ or Apple Pay™ systems, as well as physical magnetic cards or any other and any form of payment instrument.

A further technical challenge is processing complex payment scenarios within the strict time constraints of electronic payment networks. Payment authorizations typically need to be completed within seconds, leaving little time for sophisticated decision-making processes that consider multiple subaccounts, balance checks, and application of specific usage rules.

One technical solution is to implement a multi-subaccount payment card system that associates a single payment card with multiple subaccounts in a database. Each subaccount can have its own balance, funding source, and usage rules. When a payment request is received, the system rapidly determines which subaccount should be used based on data in the request, such as the merchant category code, transaction amount, or location. The system may also determine whether the payment is authorized for the relevant subaccount, based on the characteristics of the transaction. This allows for dynamic routing of transactions to the appropriate subaccount without requiring the user to physically select different cards.

As an example, it may be desired to have a single payment card to be used for both insurance-related and non-insurance-related payments. The payments may be made by associating the payment card to the user's bank account, credit or debit card, credit history/score, or by injecting a sum into a subaccount associated to the payment card, rendering the payment card a prepaid payment card. The balance of each subaccount changes in response to approving respective purchases in the payment card. Each subaccount is defined as a separate balance in a ledger, the separate balance is related to a limited entity permitted to inject money into the subaccount. For example, the payment card includes an insurance subaccount and only the insurance company can inject money into the insurance subaccount. The payment card further comprises a second subaccount, for example a personal subaccount, and only the card holder is permitted to inject money into the second subaccount. As another example, the second subaccount may be a business subaccount that enables an organization, for example a business or a government agency, to inject money into the subaccount, to enable payment of business-related transactions. That is, the person holding the payment card is not permitted to inject money into the business subaccount and is not permitted to inject money into the insurance subaccount.

Another alternative is for each subaccount of the payment card to be associated with a specific type of transaction. In some other cases, the type of purchase may be selected from insurance-related type of purchase, which is related to a first subaccount, a business-related type of purchase and personal type of purchases, all related to the same payment card. In some cases, the type may be defined according to the location from which the request is sent—bill a first subaccount when the merchant is located in California and bill a second subaccount when the Merchant is located in The United Kingdom.

Another technical solution is to integrate insurance-specific subaccounts directly into the payment card system. The system allows for the activation of insurance subaccounts associated with a user's policy, which can be funded directly by the insurance provider. When a payment request is received, the system can quickly identify if it qualifies as an insurance-related transaction and route it to the appropriate insurance subaccount. This eliminates the need for separate insurance cards or out-of-pocket payments by policyholders.

To address the time constraint challenge, the system employs efficient database structures and optimized algorithms for subaccount selection and balance checking. The use of high-performance computing resources, such as in-memory databases and distributed processing, allows for complex decision-making within milliseconds. Additionally, the system may use predictive analytics and caching mechanisms to pre-compute likely scenarios, further reducing response times.

One technical effect of the multi-subaccount payment card system is a significant reduction in the number of physical or virtual payment cards a user needs to manage. This simplification decreases the cognitive load on users, reduces the risk of using incorrect payment methods, and lowers the overall cost of card issuance and management for financial institutions and insurance providers.

A further technical effect is the ability to implement complex payment rules and restrictions without impacting transaction processing times. The system's ability to rapidly select the appropriate subaccount and apply relevant usage rules allows for sophisticated financial products, such as health savings accounts with specific eligible expense categories, to be seamlessly integrated into everyday payment scenarios.

Yet a further technical effect is to enable to introduction of mutli-subaccount payment cards within the pre-existing technological environment handling processing of single-account payment cards processing. The introduction of the mutli-subaccount payment cards does not require any changes to the existing computerized environment in which payments are authorized. Hence, the payment terminal, also referred to as “transaction terminal”, handling the payment processing may be a general purpose payment terminal that is not specifically configured to handle multi-subaccount payment cards and is unaware of the true nature of the payment card that is being used.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

The subject matter in the present disclosure discloses a system and method for managing and processing payments made by a payment card at a point of sale, for example via a payment terminal. The payment card has multiple subaccounts in a database of an authorization server configured to authorize the payment to the point of sale. For example, one subaccount may be related to insurance and another subaccount may be related to general matters, such as clothing, transportation, restaurants and additional purchases. The insurance subaccount is uniquely configured to be used for purchases that relate to the insurance agreement between the user and the insurance company. The insurance agreement may be medical insurance. The authorization server receives a request to authorize a transaction made by the payment card, and determines the respective subaccount to debit, and whether or not to authorize the transaction according to the respective subaccount's definitions.

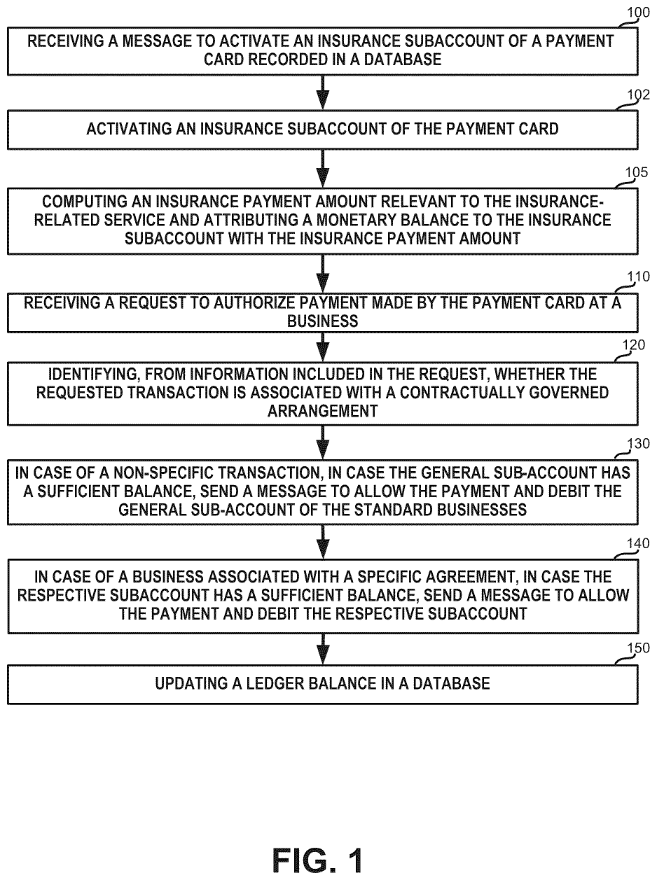

FIG. 1 shows a method for processing payments made by a payment card, according to exemplary embodiments of the subject matter.

The payment card may be a multi-account payment card. The payment card may be a prepaid payment card into which a customer injects money from another resource, for example using a bank transfer or a credit card. Hence, when beginning the process, a user has a payment card connected to an authorization server configured to authorize the purchases made using the payment card, for example, according to the balance of the prepaid card, balance in a bank account connected to the payment card, allocated credit, and the like. The payment card may have multiple subaccounts and respective balances. A non-limiting list of potential subaccounts may be a travel expense account, an insurance account (e.g., for paying insured event directly), a general spending account, a healthcare savings account (HSA) for tax-advantaged medical expenses, an employment expenses subaccount for business-related purchases, a cryptocurrency subaccount for holding and spending digital assets, a foreign currency account (e.g., account for US dollars, account for Canadian dollars, account for Euros, or the like) for transactions in foreign currency.

Step 100 discloses receiving a message to create an insurance subaccount of a payment card recorded in a database. The message may be received at a server operated by the insurance company that provided the payment card. The server may be a web server, a computer, a virtual machine, and the like. The message may be received from an electronic device operated by the user wishing to activate the insurance subaccount at the insurance server, for example by entering a mobile application running on the user's electronic device, such as a cellular phone, tablet, and the like, or by sending a text message or an instant message application such as WhatsApp.

In case the user needs to pay for an insurance-related service via the insurance subaccount, the user may send a request to activate the insurance subaccount using a user's device to the insurance server.

Upon receiving the request to activate the insurance subaccount, the insurance server performs step 102 of activating an insurance subaccount of the payment card. The insurance subaccount may be activated after the insurance claim is checked against an insurance contract and plan between the user and an insurance plan sponsor (such as an insurance company or employer). The activation may be implemented by adding a record related to a specific payment card. The request to activate the insurance subaccount may include identifiers of the person, such as age, gender, ID number, password, and the like. The message may also include data representing the person's insurance-related need. For example, when the insurance event is health related, the message may include information related to the medical condition, and information related to the required service provider such as medical specialty (cardiology, orthopedics, ophthalmology, and the like). For example, the database may have multiple devices' identifiers, or messaging accounts' identifiers, and payment cards related to the devices' identifiers. In some cases, the insurance subaccount may be activated only after verifying that the insurance claim is covered by the insurance agreement between the person and the insurance company. For example, the insurance claim may include a description of a dental treatment which may be excluded in the insurance plan.

Step 105 discloses computing an insurance payment amount relevant to the insurance-related service and attributing a monetary balance to the insurance subaccount with the insurance payment amount. The insurance payment amount limits the available balance on the payment card to be used to pay for insurance-related purposes from the insurance subaccount. Attributing a monetary balance to the insurance subaccount with the insurance payment amount comprises a step of updating a database used by the insurance server with the insurance balance. In some cases, before the injection of the insurance payment amount, the balance at the insurance subaccount is zero (0).

Step 110 discloses receiving a request to authorize a payment made by the payment card at a business using a payment terminal. The request includes the amount of the requested purchase and an identifier of the payment card. The request may include additional data, such as the business identifier, business address/location, country in which the transaction is made, currency identifier, Merchant Category Code (MCC), time information (e.g., time of day, time of week, absolute time), a type of payment terminal (e.g., some merchants may use different payment terminals for different products. For example, one payment terminal type for general purchases at CVS™ and a different payment terminal type for selling medicine over the counter), and the like. The request may be sent over a communication network such as the internet, cellular networks, satellites and the like.

Step 120 discloses identifying, from information included in the request, whether the requested transaction is associated with a contractually governed arrangement, for example a transaction type which meets the criteria of an eligible insurance-related service such as a medical facility thus associating such transaction with the respective balance. The identification may be based on a decision tree. For example, the identification comprises a step of detecting whether or not the business is related to a merchant category code (MCC) of the insurance. For example, only businesses having a code included in a closed list of codes may relate to the insurance balance. The information included in the request may be compared with the information included in the message sent to activate a target-specific subaccount such as an insurance subaccount, as received in step 100. For example, in case the message in step 100 specifies an insurance contract covering dental services only, the authorization request will not associate an authorization request from a different medical field, such as from an ophthalmology clinic with the insurance subaccount. In some cases, the identifying comprises computing a confidence score for the request based on the information included in the request. The confidence score represents a probability or a likelihood that the payment requested in the request is for purposes relevant to a specific subaccount. For example, medical purposes in case of medical insurance, car repair purposes for vehicle insurance and the like. The attribution of a transaction to a designated subaccount is cardholder-specific. Namely, in some cases, a purchase is identified to be related to a field which is commonly related by specific subaccounts but is not covered in the case of the specific customer. For example, the person holding the payment card has a medical insurance agreement that excludes dental treatments while the requested payment specifies payment for a dental implant. In such case, the purchase will not be considered as associated with the insurance subaccount.

In some exemplary cases, determining a selected subaccount, whether the payment is related to the first type or to the second type, is done in a priority-based process. That is, first checking whether the purchase is related to the highest-priority subaccount, for example the business subaccount, and if the purchase is not related to the highest-priority subaccount continue and check the second highest-priority subaccount, for example the insurance subaccount, and if not, check the third highest-priority subaccount, for example purchases made in a specific currency. If all the priority subaccounts do not match the transaction, the system will associate the transaction with the default subaccount, for example a personal subaccount.

Step 130 discloses in case of a non-specific transaction, in case the general (default) subaccount has a sufficient balance, send an authorization message to allow the payment and debit the general subaccount of the standard businesses. The message may be sent directly to a terminal used by the business to send the payment authorization, or to an intermediate server that performs additional processes, such as verifying that the purchase is valid and not part of a fraud or card theft. In case the balance is insufficient, send a message that does not authorize the purchase.

Step 140 discloses in case of a business associated with a specific agreement such as an insurance agreement, in case the respective subaccount has a sufficient balance, send an authorization message to allow the payment and debit the insurance subaccount. In case the balance is insufficient, send a message that does not authorize the purchase.

Step 150 discloses updating a ledger balance in a database. The database comprises logs for multiple users who hold card and subsequently accounts (and subaccounts). At first, the users have subaccounts used for general purposes. These accounts may be prepaid—holding a preloaded monetary amount—or debit-tied to a bank account of the user. After activating an additional card usage purpose, such as insurance, the respective subaccount is activated or a new subaccount is created. Authorizing a transaction results in updating the relevant subaccount ledger, according to the identification made on step 120 with respect to the designation of the transaction, for example whether the transaction is related to an insurance agreement or to general purposes.

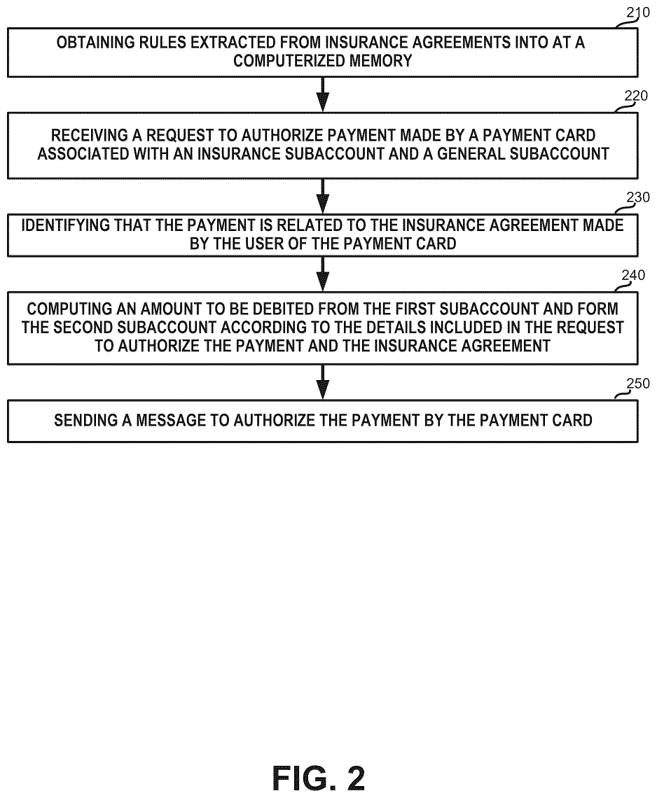

FIG. 2 shows a method for applying rules from commercial agreements on payments made by a pre-paid payment card, according to exemplary embodiments of the subject matter.

Step 210 discloses obtaining rules extracted from insurance agreements into at a computerized memory, for example, a memory of the insurance server. A rule may be defined as a sum required to be paid by a person or entity given a predefined condition. For example, an insurance agreement dictates that payments of over 800 USD from the insurance subaccount incur participation at a rate of 20 percent from the insured person's general subaccount. That is, when the bill is 1,200 USD, the difference is 400 USD (1,200 less the limit of 800) and the user will be debited at 80 USD, which is 20 percent of the difference.

Step 220 discloses receiving a request to authorize payment made by a payment card associated with an insurance subaccount and a general subaccount. The request is received in a digitized data format and includes the identity of an insured party correlated to an individual unique identifier of one of said dedicated payment cards. The request also comprises an indicator of a claim category for a given insurance claim, an amount of the requested automated remote payment for the given insurance claim, and a geographical location associated with the given insurance claim for the requested automated remote payment.

Step 230 discloses identifying that the payment is related to the insurance agreement made by the user of the payment card and an insurance company that operates or uses the insurance server that performs the method.

Step 240 discloses computing an amount to be debited from the first subaccount and from the second subaccount according to the details included in the request to authorize the payment and the policy governing such second subaccount, for example an insurance contract. The second subaccount may be used to debit a funds injected only by the insurance company and the first subaccount may be used to debit a funds injected only by, or on behalf of, the card holder.

The amount may be computed after identifying a rule in the insurance agreement that matches information or parameters in the request to authorize payment. For example, the request may include a type of services specified in the insurance agreement as a type of service that requires payment from the person's subaccount from the first dollar, at a rate of 15%. In another example, the type of service, or the location from which the payment request is sent, dictates a maximum allowed sum to be debited from the insurance subaccount, regardless to the sum appearing in the payment request. For example, even if the payment request is for $2,500, the insurance subaccount will be debited at $600, which is the maximal value appearing in the insurance agreement. In some other cases, for example, the amount to be debited from the personal subaccount is 12 percent of any transaction related to insurance, with a maximum of 120 US dollars. Other example parameters which may cause different debit patterns between subaccounts may be merchant details, location, date and time, and currency.

Step 250 discloses sending a message to authorize the payment by the payment processor. The message is sent in case the balance in the first subaccount is higher than the amount computed for the first subaccount and the balance in the second subaccount is higher than the amount computed for the second subaccount. The message may be sent over a communication network, such as the internet, intranet, LAN, WAN and the like. The message may be sent after a verification process. For example, in case of an insurance related transaction, the insurance server may verify, among others, the following parameters: a. the identified insured party is of a type entitled to receive the requested automated remote payment; b. the amount of the requested automated remote payment; c. the geographical location of the requested automated remote payment is a location where the identified insured party is entitled to receive the requested automated remote payment; and d. the amount of the requested automated remote payment for the given insurance claim is within a range of allowable payment amounts for an insurance claim: (i) of the same category as the given insurance claim, and (ii) originating within the location associated with the given claim;

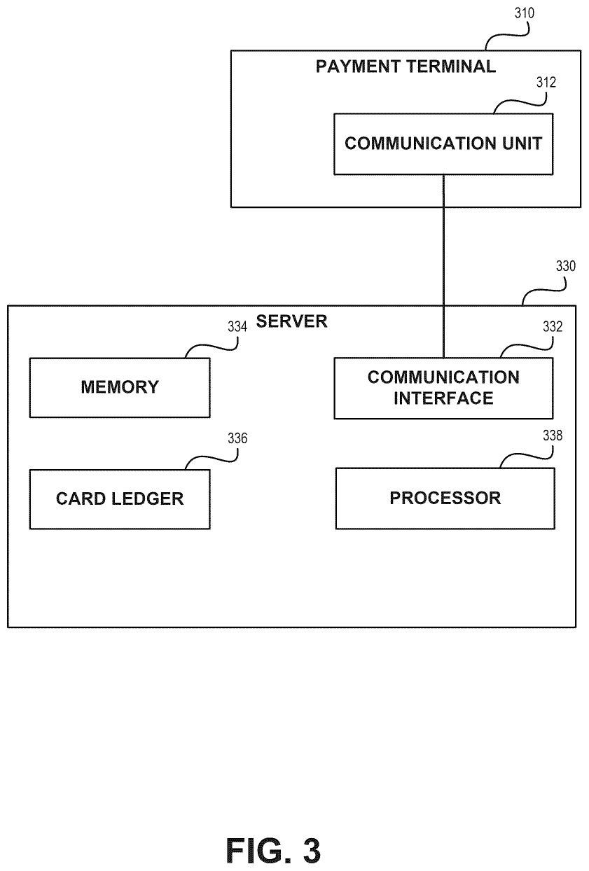

FIG. 3 shows a computerized environment for handling payments in a payment card, according to exemplary embodiments of the subject matter. The computerized environment comprises a payment terminal 310 located at a business. The payment terminal 310 is a tangible device, or a component in a tangible device, configured to collect information from a payment card 320, for example via scanning, wireless communication, an input unit capable of inserting alphanumeric symbols, and the like. The payment terminal 310 comprises a communication unit 312, for example, an internet gateway, a wireless antenna and the like, configured to send a payment request to a server 330 that processes the request. The server 330 may be used or operated by a card scheme, processor, or acquirer. The server 330 is configured to perform the following processes.
1. Payment Authorization: The server 330 comprises a payment gateway that receives the transaction request and communicates with the entity that manages the payment card. The issuing entity may be a bank or any organization that manages the ledger 336 and verifies whether the customer's account has sufficient funds or credit to complete the transaction.
2. Authorization Response: The server 330 sends an authorization response to a payment gateway coupled to the payment terminal 310. If the transaction is approved, the response includes an authorization code. If it's declined, the response indicates the reason for the decline.
3. Payment Gateway Response: The payment gateway relays the authorization response to the payment terminal 310. If the transaction is approved, the customer sees a confirmation message.

The computerized environment comprises a server 330 configured to process the payment request sent from the payment terminal 310. The request comprises an identifier of the business, an identifier of the payment card, an amount to be paid from the payment card, and optionally additional information such as the business location, merchant category code (MCC), time information, and the like. The server 330 comprises a communication interface 332 configured to communicate with the payment terminal 310, both in receiving the request and authorizing or denying the request, a memory 334 configured to store a set of rules for processing requests, a card ledger 336 for storing the balances of the payment cards supervised or authorized by the server and a processor 338 configured to process the payment requests according to the sets of rules and the cards' ledger. The memory 334 may be selected from RAM (Random Access Memory), ROM (Read-Only Memory), Cache Memory, Flash Memory, SSD (Solid-State Drive), HDD (Hard Disk Drive), Virtual Memory, GPU Memory (Graphics Processing Unit Memory), NVRAM (Non-Volatile RAM), EDRAM (Embedded DRAM), VRAM (Video RAM), MRAM (Magnetoresistive RAM), PRAM (Phase-Change RAM), SDRAM (Synchronous DRAM) and DDR RAM (Double Data Rate RAM).

The processor 338 may be CPU (Central Processing Unit), GPU (Graphics Processing Unit), FPGA (Field-Programmable Gate Array), DSP (Digital Signal Processor), ASIC (Application-Specific Integrated Circuit), MCU (Microcontroller Unit), SoC (System-on-Chip), VPU (Vision Processing Unit), NPU (Neural Processing Unit), Coprocessor, RISC Processor (Reduced Instruction Set Computer), CISC Processor (Complex Instruction Set Computer), Multi-Core Processor, Quantum Processor (Quantum Computer) and AI Accelerator.

The ledger 336 may be defined as a record-keeping system used to track financial transactions. The ledger 336 may store a record of all financial transactions of the persons having payment cards issued by an organization. The ledger 336 records not only user balances but also every individual financial transaction. A ledger typically consists of accounts, each representing a specific financial element or category. Transactions are posted to these accounts to maintain a detailed and accurate financial history. The ledger 336 may be a General Ledger, Accounts Receivable Ledger, Accounts Payable Ledger, Cash Receipts Ledger, Cash Disbursements Ledger, Sales Ledger, Purchase Ledger, Revenue Ledger, Expense Ledger, Subsidiary Ledger, Trial Balance Ledger, Ledger for Credit Card Payments, Ledger for Bank Transfers, Ledger for Digital Wallet Transactions and Ledger for Cryptocurrency Transactions.

The server 330 may be operated by a payment instrument issuer, processor, program manager, or the like. In some cases, the policies that server 330 implements may be defined by a third-party, such as but not limited to a business account holder, an owner of an account that is connected to the payment card, an insurance company, an insurance administrator, a third-party administrator (TPA) that also manages payments on the payment card for insurance purposes, or the like.

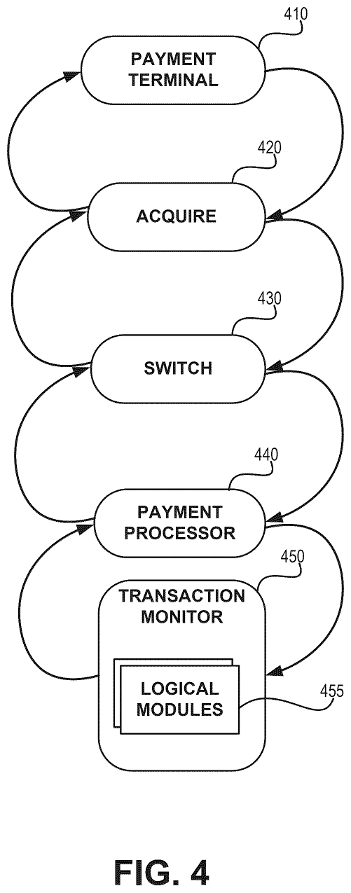

FIG. 4 illustrates an electronic transaction processing network, in accordance with some exemplary embodiments of the disclosed subject matter. Payment Terminal 410 may be located at a business and configured to initiate payment transactions. Additionally, or alternatively, Payment Terminal 410 may connect to Acquirer Module 420, which may receive initial transaction requests from Payment Terminal 410.

Acquirer Module 420 may be related to an acquirer institution. The acquirer provides the necessary infrastructure and support, including merchant accounts, to process card transactions. When a customer makes a purchase using a card, the acquirer communicates with the relevant entities through the card network to authorize and settle the transaction, ensuring that funds are appropriately transferred to the merchant's account. Acquirer Module 420 may interface with Switch Module 430.

Switch Module 430 may be a software system that facilitates the routing of electronic transactions between various payment methods and financial institutions. Switch Module 430 may act as an intermediary, dynamically directing payment data to the appropriate entity based on predefined rules. This dynamic routing enhances transaction efficiency, reduces processing times, and provides redundancy by allowing transactions to be redirected in case of acquirer outages or low approval rates. Additionally, Switch Module 430 may incorporate security measures such as encryption and tokenization to protect sensitive payment information during transmission.

In some exemplary embodiments, Switch Module 430 may route transactions between Acquirer Module 420 and Payment Processor 440. Payment Processor 440 may handle payment processing functions. In some cases, before approving or declining a payment associated with a multi-subaccount payment card, Payment Processor 440 may invoke Transaction Monitor 450, similar to Server 330.

In some exemplary embodiments, Transaction Monitor 450 may be in charge of matching a subaccount of the payment card with the transaction. Additionally, or alternatively, Transaction Monitor 450 may ensure that the transaction is in line with the rules associated with the matched subaccount. Additionally, or alternatively, if the transaction is to be approved, Transaction Monitor 450 may ensure sufficient balance exists in the relevant subaccount. Additionally, or alternatively, in case there's insufficient balance, credit balance may be examined. Transaction Monitor 450 may process the transaction and return an “approved” or “declined” response.

In some cases, Transaction Monitor 450 may cause a message to be sent to a human user, such as the credit card holder, notifying the user of a specific issue. For example, a text message may be sent indicating to the credit card holder that the transaction was matched to an insurance subaccount, however it is not line with the rules of the insurance subaccount. The user may be prompted to reply (e.g., send “1”) to instruct the Transaction Monitor 450 that in a next attempt to process the same transaction, the subaccount to be used will be a different subaccount (e.g., personal), thereby overriding the automatic decision of the Transaction Monitor 450.

In some exemplary embodiments, Transaction Monitor 450 may include Logical Modules 455 for validating transactions. Additionally, or alternatively, Logical Modules 455 may be implemented in an efficient manner to ensure that the entire process from transaction request issued by Payment Terminal 410 until the response is provided thereto is performed within a predefined timeframe, such as 5 seconds, 4 seconds, or the like.

In some cases, Logical Modules 455 may be implemented using a serverless workflow orchestration mechanism in combination with stateless compute functions and concurrency management to meet a specific processing deadline (for example, about four seconds). Additionally, or alternatively, this approach enables separation of each logical phase and precise monitoring of process execution from initiation to completion, thereby facilitating efficient fault detection and performance assessment.

In some exemplary embodiments, an initial stateless compute function may retrieve all relevant data from a database at the outset to minimize subsequent calls and improve response time.

Additionally, or alternatively, each compute function in the orchestration may utilize a concurrency management feature designed to keep the function in a “warm” state, thereby avoiding latency spikes that can introduce significant delays (e.g., approximately one second of delay). It is noted that with serverless functions (such as AWS™ Lambda, Google Cloud™ Functions, or Azure™ Functions), a cold start occurs when a function is executed after being idle, requiring the cloud provider to allocate resources and initialize the function. This initialization can introduce latency, often in the range of hundreds of milliseconds to several seconds. Keeping a function in a “warm” state means ensuring that it remains pre-initialized and ready to execute immediately, avoiding the overhead of a cold start. This is achieved using techniques like provisioned concurrency, scheduled invocations, or background processes.

In some cases, each stateless compute function may be structured as a module, enabling advanced asynchronous features (e.g., top-level await or pre-initialization of database connections) to run before execution begins. Additionally, or alternatively, such design can substantially reduce overhead during each execution, helping the system to handle complex payment processes within the stringent time constraints imposed by electronic payment networks.

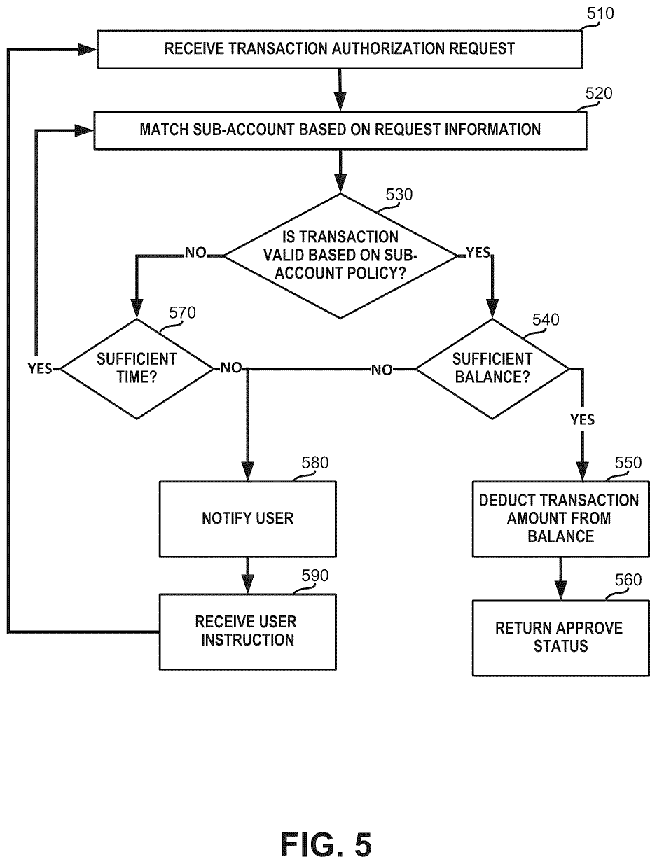

In some exemplary embodiments, FIG. 5 illustrates a flowchart for processing a transaction authorization request. The process begins at Step 510 with receiving a transaction authorization request. This request may be received by Server 330 from Payment Terminal 310 via Communication Unit 312.

The process continues to Step 520, where Processor 338 matches a subaccount based on request information received in the transaction authorization request. If there are a plurality of potentially matched subaccount, the highest priority is selected. In some cases, Processor 338 may obtain multiple records in Card Ledger 336, each record associated with a payment card and including multiple subaccounts.

At Step 530, a decision point determines if the transaction is valid based on subaccount policy. The transaction is determined to be valid or invalid based on the policy and based on the parameters of the transaction itself, such as MCC, type of payment terminal, time information, geographic information, merchant identifier, transaction amount, transaction currency, or the like. The validation may be performed based on hard-coded rules. Additionally, or alternatively, the validation may be performed based on a machine learning or AI-based predictor that was trained using historic transactions associated with a similar policy. For example, a policy for insurance-based claim for a specific illness may be checked based on historic transactions made for the same specific illness at the same country.

If the transaction is valid, the process moves to Step 540. If the transaction is not valid, the process moves to Step 570.

In some exemplary embodiments, at Step 540, another decision point checks if there is sufficient balance in the matched subaccount. If there is sufficient balance, the process proceeds to Step 550. If there is insufficient balance, the process moves to Step 570.

Additionally, or alternatively, at Step 570, the process is stopped due to an invalid transaction decision (Step 530). In some cases, Processor 338 may check if there is sufficient time to continue processing, so that the response would be provided timely and before a timeout event occurs. If there is sufficient time, the process returns to Step 520 to attempt to identify another account (e.g., with lower priority) that would match the transaction and for which the transaction would be valid. If there is insufficient time, the process moves to Step 580.

Additionally, or alternatively, if the transaction was determined to have sufficient balance at Step 540, the process moves to Step 550 where the transaction amount is deducted from the balance of the matched subaccount. The process then concludes at Step 560 with returning an approve status.

In some exemplary embodiments, Step 580 involves returning a “decline” status for the transaction, which is routed to the Payment Terminal 410. Step 580 may also involve notifying the user that the transaction is being declined. This notification may be made in addition to the notification via the Payment Terminal 410. In some cases, the notification may be useful to get feedback from the user. In Step 590, Server 330 receives user instructions that may be useful for a next attempt to make the same transaction. For example, if the insurance subaccount policy declined the transaction, the user may instruct to complete the transaction via his personal account instead. As another example, if the matched subaccount was a foreign currency subaccount that has insufficient balance, the user may decide to use a different account instead (e.g., default personal spending account). As yet another example, if the transaction failed with respect to a travel expense subaccount, the user may decide to use instead a foreign currency subaccount.

It is noted that in decision point at Step 570 indicates sufficient time, a new matched subaccount may not be selected at Step 520. For example, if the second-matched subaccount is of a lower preference, a user instruction may be required before attempting to use such account. For example, if the insurance subaccount is not utilized, the user may not agree to use his personal subaccount and instead may change the transaction that is being attempted to be made.

After Step 590, the Payment Terminal 410 may attempt to get the same transaction approved again. It is noted that the second attempt is not exactly the same transaction (e.g., it may have a different transaction identifier, a different timestamp, or the like), but it has the same values for a set of parameters such as transaction amount, currency, MCC, merchant identifier, or the like. When a second transaction is made (within a predetermined time window from the first transaction), the process may take into account the previous processing and any user input received (Step 590). The process may return to Step 510 to process a subsequent attempt to approve the same transaction. For example, if processing has stopped due to insufficient time, additional processing may be performed immediately. As another example, if the user approved usage of a specific subaccount, matching at Step 520 may be based on the user input.

In some exemplary embodiments, the multi-subaccount payment processing system may handle currency conversions for international transactions across different subaccounts. Additionally, or alternatively, this capability may enable users to seamlessly conduct transactions in various currencies without the need for multiple cards or accounts.

In some cases, the system may maintain subaccounts in different currencies. Additionally, or alternatively, when a transaction is initiated in a foreign currency, the system may automatically select the appropriate currency subaccount if available. In some exemplary embodiments, if a matching currency subaccount is not available or has insufficient funds, the system may perform real-time currency conversion from another subaccount.

Additionally, or alternatively, the currency conversion process may utilize current exchange rates obtained from reliable financial data providers. In some cases, the system may apply a small markup or fee for the currency conversion service, which may be transparently disclosed to the user.

In some exemplary embodiments, the system may offer users the ability to set preferences for currency conversions. Additionally, or alternatively, users may specify a preferred order of subaccounts to use for foreign currency transactions or set thresholds for automatic conversions.

Additionally, or alternatively, the system may implement sophisticated algorithms to optimize currency conversions across multiple subaccounts. In some cases, these algorithms may consider factors such as current exchange rates, conversion fees, and account balances to determine the most cost-effective way to process an international transaction.

In some exemplary embodiments, the system may provide users with detailed transaction records that clearly indicate the original transaction currency, the currency of the subaccount used, the exchange rate applied, and any associated fees. Additionally, or alternatively, this transparency may help users track their spending across different currencies and subaccounts more effectively.

Additionally, or alternatively, the system may incorporate machine learning techniques to predict currency fluctuations and optimize the timing of currency conversions. In some cases, this may help minimize conversion costs for users over time.

In some exemplary embodiments, the system may offer virtual currency subaccounts, allowing users to hold and transact in cryptocurrencies alongside traditional fiat currencies. Additionally, or alternatively, the system may perform conversions between cryptocurrencies and fiat currencies as needed for transactions.

Additionally, or alternatively, the multi-subaccount payment processing system may implement robust security measures to protect against fraud and unauthorized transactions, especially for international and cross-currency transactions. In some cases, these measures may include advanced encryption, multi-factor authentication, and real-time transaction monitoring.

In some exemplary embodiments, the system may provide APIs (Application Programming Interfaces) that allow third-party financial services to integrate with the multi-subaccount payment processing system. Additionally, or alternatively, this may enable the development of additional features and services that leverage the system's multi-currency and multi-subaccount capabilities.

Additionally, or alternatively, the system may offer dynamic currency conversion options at the point of sale, allowing users to choose whether to process a transaction in the local currency or their home currency. In some cases, this feature may provide users with greater control and transparency over their international transactions.

In some exemplary embodiments, the system may implement a caching mechanism for frequently used exchange rates to reduce latency in currency conversion calculations. Additionally, or alternatively, this may help ensure that currency conversions can be performed within the strict time constraints of payment processing networks.

Additionally, or alternatively, the multi-subaccount payment processing system may provide tools for businesses to manage multi-currency transactions and expenses across different subaccounts. In some cases, this may include features such as automatic categorization of expenses, currency hedging options, and detailed reporting for accounting purposes.

In some exemplary embodiments, the system may offer a feature to automatically balance currency holdings across subaccounts based on user-defined rules or AI-driven optimization. Additionally, or alternatively, this may help users maintain desired currency allocations without manual intervention.

Additionally, or alternatively, the system may implement a distributed ledger or blockchain-based solution for tracking and reconciling multi-currency transactions across subaccounts. In some cases, this may enhance the transparency, security, and auditability of international transactions.

In some exemplary embodiments, the multi-subaccount payment processing system may provide users with alerts and notifications related to currency fluctuations, low balances in specific currency subaccounts, or opportunities for advantageous currency conversions. Additionally, or alternatively, these features may help users make informed decisions about their multi-currency transactions and account management.

It should be understood that the above description is merely exemplary and that there are various embodiments of the present disclosed subject matter that may be devised, mutatis mutandis, and that the features described in the above-described embodiments, and those not described herein, may be used separately or in any suitable combination; and the invention can be devised in accordance with embodiments not necessarily described above.

The flowchart and block diagrams in the figures illustrate the architecture, functionality, and operation of possible implementations of systems, methods, and computer program products according to various embodiments of the present disclosed subject matter.

The terminology used herein is for the purpose of describing particular embodiments only and is not intended to be limiting of the disclosed subject matter. It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1. A method comprising:
receiving, at a server, a request to authorize a transaction made by a multi-subaccount payment instrument at a transaction terminal, wherein the multi-subaccount payment instrument is associated with multiple subaccounts, the multiple subaccounts comprise at least a first subaccount and a second subaccount, the first subaccount is configured to be used for transactions of a first type, the second subaccount is configured to be used for transactions of a second type;
automatically selecting, by the server without user input a selected subaccount from the multiple subaccounts, wherein said selecting is performed based on information included in the request and based on a policy that is associated with the selected subaccount;
verifying sufficient funds in the selected subaccount;
in response to said verifying, allocating funds from the selected subaccount; and
in response to said verifying. sending an authorization message indicating that the transaction is approved.

2. The method of claim 1, wherein said automatically selecting the selected subaccount comprises:
determining a priority order for the multiple subaccounts; and
selecting the subaccount with the highest priority that matches criteria in the transaction request.

3. The method of claim 2, wherein the criteria include at least one of:
merchant category code (MCC),
transaction amount,
transaction location, or
transaction currency.

4. The method of claim 1, wherein said automatically selecting comprises:
selecting by the server without user input, a potential subaccount based on the information included in the request;
retrieving from a database, a policy associated with the potential subaccount; and
determining whether the transaction is valid based on the policy of the potential subaccount and based on the information included in the request.

5. The method of claim 4, further comprising:
if the transaction is invalid for the potential subaccount, selecting a next subaccount based on a predefined priority order.

6. The method of claim 5, further comprising:
notifying a user of the multi-subaccount payment instrument about the selection of the next subaccount.

7. The method of claim 1, wherein the policy associated with the selected subaccount includes rules for transaction types, spending limits, geographical restrictions, or time-based restrictions.

8. The method of claim 1, further comprising:
performing a currency conversion if the transaction currency differs from the currency of the selected subaccount.

9. The method of claim 1, wherein said allocating funds from the selected subaccount comprises:
updating a ledger balance of the selected subaccount in a database by deducting a transaction amount from the balance of the selected subaccount.

10. The method of claim 1, further comprising:
receiving, at the server, a request to activate the selected subaccount, wherein the request to activate the selected subaccount is received before receiving the request to authorize the transaction; and
injecting the selected subaccount with a maximum transaction amount, wherein the maximum transaction amount limits an amount of money the payment instrument can be used to pay using the selected subaccount.

11. The method of claim 1, wherein said receiving the request, said automatically selecting the subaccount, said verifying sufficient funds, said allocating funds, and said sending the authorization message are completed within a predetermined time threshold of four seconds from receipt of the request.

12. The method of claim 1, wherein said automatically selecting the subaccount is implemented using a serverless workflow orchestration mechanism in combination with one or more stateless compute functions, wherein relevant data is retrieved from a database using an initial stateless compute function, thereby reducing subsequent database calls, wherein the one or more stateless compute functions are maintained in a warm state, whereby facilitating efficient execution of said automatically selecting the subaccount within a timeframe.

13. A system comprising:
a transaction terminal;
a database storing information about multiple subaccounts associated with a multi-subaccount payment instrument, wherein the multiple subaccounts comprise at least a first subaccount configured for transactions of a first type and a second subaccount configured for transactions of a second type; and
a server, wherein the server is configured to:
receive a request to authorize a transaction made by the multi-subaccount payment instrument at said transaction terminal;
automatically select, without user input, a subaccount from the multiple subaccounts based on information included in the request and a policy associated with the selected subaccount in said database;
verify sufficient funds in the selected subaccount;
in response to verifying sufficient funds, allocate funds from the selected subaccount; and
in response to verifying sufficient funds, send an authorization message indicating that the transaction is approved.

14. The system of claim 13, wherein said transaction terminal and said server are connected via an electronic transaction processing network, wherein the request is transmitted by said transaction terminal to said electronic transaction processing network and routed to said server, wherein the authorization message is transmitted by said server to said electronic transaction processing network and routed to said transaction terminal.

15. The system of claim 14, wherein said electronic transaction processing network has a timeout constraint, wherein said server is configured to send the authorization within the timeout constraint,

16. The system of claim 15, wherein said server implements at least a portion of a logic for automatically selecting the subaccount using a serverless workflow orchestration mechanism in combination with one or more stateless compute functions.

17. The system of claim 16, the one or more stateless compute functions utilize data retrieved from said database using an initial stateless compute function, thereby reducing subsequent database calls.

18. The system of claim 16, wherein the one or more stateless compute functions are maintained in a warm state, whereby facilitating efficient execution of automatically selecting the subaccount within the timeout constraint.

19. The system of claim 13, wherein the policy associated with the selected subaccount includes rules for transaction types, spending limits, geographical restrictions, or time-based restrictions.

20. The system of claim 13, wherein the automatic selection of the subaccount comprises:
selecting a potential subaccount based on the information included in the request;
retrieving from said database a policy associated with the potential subaccount; and
determining whether the transaction is valid based on the policy of the potential subaccount and based on the information included in the request.
